(19) United States
(12) Patent Application Publication
(10) Pub. No.: US 2019/0376277 A1
(43) Pub. Date: Dec. 12, 2019

(54) SEMI-MOBILE SELF-STANDING BUILDING SUPERSTRUCTURE WITH SELF-INSULATING ELECTRICITY ACCUMULATING EVACUATED VOLUME

(71) Applicant: Bruno CHAVANNE, Azay-sur-Indre (FR)

(72) Inventor: Bruno CHAVANNE, Azay-sur-Indre (FR)

(21) Appl. No.: 16/487,463

(22) PCT Filed: Feb. 21, 2017
(86) PCT No.: PCT/EP2017/053917

§ 371 Date: Aug. 21, 2019

(51) Int. Cl. E04B 1/343; E04B 1/88; E04H 9/02; E04B 1/64; E04B 1/92; E04C 5/00; A01G 9/16; A01G 9/24

(52) U.S. Cl. CPC E04B 1/34384; E04B 1/88; E04H 9/021; E04B 1/644; E04B 2001/742; E04C 5/00; A01G 9/16; A01G 9/243; E04B 2001/925; E04B 1/92

(57) ABSTRACT

Self-standing, thermally-insulating, noise-insulating, seismically-insulating, water-insulating, electromagnetic-insulating superstructure, whose overall internal volume is filled with rigid and lightweight granules, in which the dwelling rooms are immersed. The lightweight granules are spherical, porous or hollow, they have no binder and are scattered. A gas-tight skin clads all the outer surface of the superstructure's shell and the walls of the dwelling quarters. Gas-tight bay-frames of conical outer shape are embedded in the openings and bays. The entire volume, made up of the scattered granules, the plates, the bay-frames and the gas-tight skin, is under gas-vacuum. This gas-vacuum is lifetime-controlled by a vacuum pump which is installed in situ. The outer casing and the inner walls are braced by the volume of granules stiffened by atmospheric pressure. A plurality of ion-polarized layers, vaporized on overlay metallized polymer vacuum sheets, are inserted between the rigid plates and the gasproof skin.

The invention lies in the field of industrial mass production of residential and public buildings with high levels of thermal, phonic, seismic and electromagnetic insulation and water ingress; without foundations, without the use of concrete, that can be assembled and dismantled endlessly, storing their own electricity production of solar origin in their shell with very low safety voltage.

It is shown that the production and use of concrete generates between 5 and 6% of anthropogenic greenhouse gas emissions in the world. Furthermore, angular sand reserves are becoming scarce.

We are familiar with the problems caused by permanent building at a time when their environment was healthy and pleasant, condemned to be destroyed following environmental degradation. The building is not savable and its demolition generates polluting waste.

The problem of uninsulated dwellings whose costly renovation is not completely satisfactory is known.

In the long run, some materials exposed to air and solar radiations are degraded by oxidation and photo-oxidation. Moisture and frost also damage them.

Dwellings constructed in a floodable and/or seismic zone and which are neither resistant to water intakes, nor to earthquakes, lead to catastrophic insurance claims.

It is suspected that electromagnetic radiations which invade homes have an adverse effect on people's health in the long run.

The harmful effects of air pollution by microparticles and agricultural chemical spraying are known.

It is shown that renewable energy production comes with the use of solar energy and that its storage is problematic.

220-volt alternating current (low voltage) causes accidents, death or after-effects for life The reason is that it makes muscles contract, contrary to direct current. Alternating voltage was developed in order to be able to modify current and to transport it at a very high voltage, but its transport induces losses. This model, which dates back to a century or more, is no longer necessary if the house produces its own electricity needs.

Many electrical and electronic appliances for mobile homes and pleasure boats use 5-or-12-volt DC voltage.

The use of vacuum insulation panels (P.I.V.), incorporated or not in walls, floors and roofs is known.

Mention will be made of patents:

FR2880639/WO2013088075/WO2013088077/WO2014128379/W2015/155438/EP2860320

These patents describe structures carrying P.I.V panels.

P.I.V. panels' drawback is to be fragile, and therefore, they are not supporting. Furthermore, it is difficult to control their long-term vacuum level for 10, 30, 100 years. Due to the fact that they are not load-bearing, it is difficult to avoid thermal bridges between the outside and the inside of the building, the necessary supporting structure is not insulating.

Patents offer much stronger P.I.V. panels, made from plasticized cardboard paper.

Mention will be made of the following patents:

WO2015135656/WO2016165984

The hereby invention proposes to find a solution to all the drawbacks mentioned on pages 1 and 2.

As a reminder, it is known that gas-vacuum insulation is the best thermal insulation. In order to stiffen, reinforce, save materials and soundproof the building structure, the invention uses a physical effect: the so-called Magdeburg effect.

When one of the two faces of a wall is under gas-vacuum, the force exerted on this wall is equal to the atmospheric pressure, i.e. 1013 hPa or mbar below sea level. This force will be used throughout the superstructure. In order to prevent the bending of the walls on which the atmospheric pressure is exerted, perfectly spherical, porous or hollow and rigid granules will be placed behind these walls. The granules will be scattered without any binder and will thus have only weak points of contact between them, which will limit the transmission of thermal flows by conduction. The porous or hollow granules will be subjected to a high gas-vacuum, which will eliminate the transmission of thermal flows by convection.

Semantic precision: the word «shell» qualifies curved concrete sails in architecture. The word «shell» used in this application includes aboveground foundations, all planar or curved exterior walls, and planar or curved coverage.

### DESCRIPTION OF THE INVENTION

### Summary of the Invention

Self-standing, thermally-insulating, noise-insulating, seismically-insulating, water-insulating, electromagnetic-insulating superstructure, whose overall internal volume is filled with rigid and lightweight granules, in which the dwelling rooms are immersed. The lightweight granules are spherical, porous or hollow, they have no binder and are scattered. The outer casing of the superstructure's shell and the walls of the dwelling rooms are composed of contiguous rigid plates whose inner faces are lined with a plurality of corrugated ribs. A gas-tight skin clads all the outer surface of the superstructure's shell and the walls of the dwelling quarters. The gas-proof skin consists of sheets cladding the outer face of each rigid plate, which are connected by their gas-tight edges. These sheets consist of a sheet of cardboard paper, gas-proofed by means of an Ethylene Copolymer/Vinyl Alcohol (EVOH) inner film, and are fire-resistant and rot-proof thanks to the outer face's chloroparaffin application. Gas-tight bay-frames of conical outer shape are embedded in the openings and bays. The entire volume, made up of the scattered granules, the plates, the bay-frames and the gas-tight skin, is under gas-vacuum. This gas-vacuum is lifetime-controlled by a vacuum pump which is installed in situ. The outer casing and the inner walls are braced by the volume of granules stiffened by atmospheric pressure. A plurality of ion-polarized layers, vaporized on overlay metallized polymer vacuum sheets, are inserted between the rigid plates and the gasproof skin. The set of ionic sheets, separated by intercalated electrolytic films, constitutes gas-vacuum electrochemical accumulators or supercapacitors. The safety extra-low electrical current is drawn directly from the back of the lining partition.

Presentation: The invention suggests that the entire superstructure of a building is composed of a single insulating continuous shell, referred to as a cocoon, and that all parts are of identical composition. The composition of the inner load-bearing walls and the floors is the same as the shell's. An element can only be described as a wall, floor, or roof, depending on its position in space and in relation to other elements. The structure of this shell consists of a plurality of rigid contiguous plates enclosing artificial or plant-based granules which fill the entire volume formed by the plates. The overall volume of the superstructure is formed by a plurality of contiguous rigid plates forming an outer casing that incorporates the entire building. The dwelling rooms or reception rooms form sub-volumes whose walls are made up of a plurality of contiguous rigid plates forming internal cavities. The

volume of the shell, the inner load-bearing walls and the floors, results from the subtraction of the sub-volumes from the overall volume. The thickness of the shell, which can vary, is determined by the position of the sub-volumes in the overall volume. The sub-volumes, which are isolated units, constitute the dwelling rooms or professional rooms, they are immersed in the granules.

### FIGURES DESCRIPTION

The detailed description of the figures has been placed at the end of this description, on pages 14 to 16, for better conciseness.

FIG. 1: Representation of volumes (1) and (2), empty symbol (10).

FIG. 2: View of a building, whose gable wall is open.

FIG. 3: Zoom +1.5 on the open gable wall of FIG. 2.

FIG. 4: Detail of FIG. 2, schematic diagram of the vacuum pump.

FIG. 5: View of two floors and a wall, guyed.

FIG. 6: Open representation of the shell with more details.

FIG. 7: Representation of internal walls connected by cables.

FIG. 8: Wall element pre-assembled with spacers (7).

FIG. 9: Pre-assembled cover element with spacers (7).

FIG. 10: Zoom on the mounting corner brackets and spacers of FIG. 8.

FIG. 11: Zoom on a connecting plate (21) of FIG. 9.

FIG. 12: View of a half bay-frame with its conical embedding.

FIG. 13: Schematic representation of a skin sheet (8) with closed V-shaped edges (12) and corner seal (33).

FIG. 14: Schematic representation of a skin sheet (8) with open V-shaped edges (13) and corner seal (34).

FIG. 15: Schematic representation of the skin (8) with right-angled edges (14) and a corner seal (35).

FIG. 16: Sectional view of 2 closed V-shaped edges (12) and Ω spring clamp (23).

FIG. 17: Diagram of an interior angle of a sub-volume with closed V-shaped edges (12), Ω spring clamp (23) and tripod staple (24).

FIG. 18: Sectional view of 2 open V-shaped edges (13) and Ω spring clamp (23).

FIG. 19: Diagram of an outside corner of a volume with open V-shaped edges (13), 3Ω spring clamps (23) and tripod staple (24).

FIG. 20: View of a bay and a recessed half bay-frame (9), skin (8) with edges (14).

FIG. 21: Schematic diagram showing the plates' (3) wind-bracing principle.

FIG. 22: Representation of a tie rod inside a floor.

FIG. 23: Bolt/self-tapping screw (25).

FIG. 24: Assembly of a bolt (25) on a skeleton (46).

FIG. 25: Sectional view of an embodiment of a house on one level with a gantry shell (31) and (32).

FIG. 26: View of the complete coating of a house with the skin (8).

FIG. 27: View of a superstructure placed on a sand bed (28) with gantry-rafters (29).

FIG. 28: Schematic diagram of an electricity accumulator.

FIG. 29: Aerial view of a house with an indoor garden (49).

FIG. 30: Shell's closing cap.

FIG. 31: Section of a house with an indoor garden, ventilation (53).

### REALIZATION OF THE INVENTION

As a reminder, the invention suggests that the entire superstructure of a building should be composed of a single insulating continuous shell, called cocoon, and that all the elements should be of identical composition, including the inner load-bearing walls and the floors.

An element can only be described as a wall, floor, or roof, depending on its position in space and in relation to other elements.

The structure of this shell consists of a plurality of rigid plates (3) enclosing artificial or plant-based granules (4) which fill the entire volume formed by the plates.

The overall volume (1) of the superstructure is formed by a plurality of contiguous rigid plates (3) forming an outer casing which encompasses the entire building. It is also the rigid outer skin of the shell.

The dwelling rooms or reception rooms form sub-volumes (2) which consist of a plurality of contiguous rigid plates (3) forming internal cavities.

The volume of the shell, the inner load-bearing walls and the floors, results from the subtraction of the sub-volumes (2) from the overall volume (1).

The thickness of the shell, which can vary, is determined by the position of the sub-volumes (2) in the overall volume (1).

The sub-volumes (2), which are isolated units, constitute the dwelling rooms or professional rooms, they are immersed in the granules (4).

The plates (3) are planar or rounded, parallel to each other or not. A plate may be the size of a wall or roof pan or floor.

The plates' internal face to the shell, the inner load-bearing walls and the floors are lined with a plurality of ribs (5) which are parallel to each other in the form of corrugations or gear rack teeth. The shape of the ribs is selected according to the size of the granules. The direction of the ribs (5) is orthogonal to the shear stresses on the shell's structure, the inner load-bearing walls and the floors.

The ribs (5) will be horizontal in the case of a vertical wall or a roof pan on which the gravity force is exerted.

The plates (3) are reinforced by vaulted ribs (6), also fixed on the internal faces of these plates and on the ribs (5). These vaulted ribs (6) are perpendicular to the ribs (5). Their thickness, width and length are adapted to the transverse forces exerted on the plates.

The openings, which are necessary to create the doors and windows, the passage from one room to another, the passage of air vents, flue ways, electrical and hydraulic ducts, are formed in the plates which face each other.

The plates (3) of the shell which face each other are advantageously and internally connected by spacers (7).

The spacers (7) are composed of threads fixed on the two ribs of the plates (3) which face each other. This assembly makes it possible to create pre-assembled wall (31) and roofing elements (32) which only need to be filled with granules after the assembly process.

The pre-assembled elements (31) and (32) are interconnected by inner mounting corner brackets (15) and outer corner mounting brackets (16), as well as by connecting plates (21). The mounting corner brackets are made of steel.

The mounting corner brackets (15) and (16) are screwed onto the plates (3) and the ribs (5) with screws (17).

The sub-volumes (2), and therefore the dwelling rooms, can be encircled by a plurality of cables (19). In this case, the cables are placed on the ribs (6). The end of some vaulted ribs (6) of mutually perpendicular plates are connected by mounting corner bracket/cable guide (18).

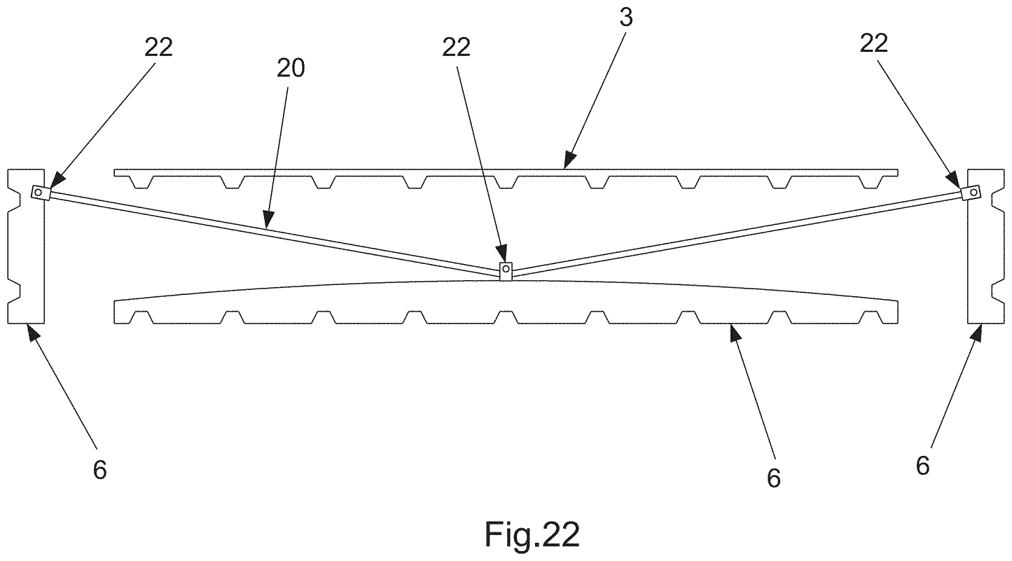

Tie rods (20) can connect some vaulted ribs (6) of the floors and the front walls. These tie rods (20) pass through the granules (4) of the gable walls, the inner load-bearing walls and the floors (see FIG. 22).

The metal tie rods (20) which are internal to the shell, the inner load-bearing walls and the floors, are fixed on the vaulted ribs (6) by means of clevises (22). These are metal rods or cables.

The internal volume of the shell, the walls and the floors is entirely filled with granules (4), which are rigid and hard, mineral or not, spherical, porous or hollow-shaped and without any binder to agglomerate them.

Several types of lightweight granules can be used:
Lightweight granules, manufactured by the expansion and crosslinking at 392° F. of a geopolymer resulting from “red muds”, which themselves are industrial waste of alumina manufacturing,
The clay expanded at 2012° F., made with quarry wash sludge or with so called noble clays,
Foam glass,
Vegetable granules such as fruit stones, for example peach, nectarine or cherry stones.

Any other type of artificial lightweight granules can be used.

It is advisable to place heavy granules at the bottom of the superstructure. A mixture of different granulometria is possible.

Semantic Precision: Precast concrete frames, used in traditional construction, which surround window and door bays are called «bay-frames».

In the hereby application, bay-frames will be used to fill the two openings made to enable the passage of electrical, electronic, hydraulic circuits, ventilation ducts, smoke ducts.

In each opening is embedded a prefabricated bay-frame (9). This bay-frame is gas-tight, it is made of wood composite resin-plastic/wood, and the plastic will come from recovered polyethylene, polypropylene or polyvinyl chloride. A solid wood construction coated with a layer of injection-molded waterproof resin is also possible. The shape of this bay-frame, whose particularity is to have an outer integrating surface, is generally conical. The dimensions of the protruding part which is outside the superstructure, and therefore of the volume (1), are greater than the dimensions of the protruding part which is inside the superstructure, and therefore of the sub-volumes (2). Each face surrounding the bay-frame has a slope of 3 to 5%.

This bay-frame protrudes on each side of the shell, its minimum total depth corresponds to the thickness of the shell plus the two thicknesses on each side of the shell and the facade reliefs. These thicknesses are made up of the thickness of the lining partition (45), the height of the wooden skeleton (46), the thickness of the facing panels (30), and the height of the gantry-rafters (29).

If this said bay-frame is embedded in an inner load-bearing wall or a floor, its depth corresponds to the thicknesses plus the width of the bay-frame/skin gas-tight edges. Note: the skin is described later.

A bay-frame (9) can be replaced by a simple cross-passage of conical bore shaped tube, this for cable ducts and pipes. In this case, the seal between the conical bushing and the skin (8) is conventional, with circular seals and clamping flanges (not shown).

A gas-tight skin (8) clads all the external surfaces of the shell's outer casing and the walls of the dwelling rooms, it consists of sheets of the same shape and dimensions as the plates (3), the sheets are assembled.

The sheets consist of cardboard paper sheets (36), which are gas-tight on their plate side's face thanks to a layer of ethylene copolymer/vinyl alcohol (EVOH) which is non-combustible and non-degradable thanks to a hot-penetrating chloroparaffin layer in their outer face. Openings, corresponding to the frames formed in the plates (3), are formed in the sheets.

The borders of the cardboard sheets are folded outwards (from the shell) over a width of 40 mm, the edges are raised and form, with the cardboard sheet, either a closed V-angle (12), or an open V-angle (13), or a right angle (14).

These folds are intended to connect the sheets together by pinching the pairs of raised edges which are in contact.

The right-angle folds (14) are intended to connect the gas-tight bay-frame with the raised edges of the holes in the sheets. The shape and dimensions of the openings strictly match the dimensions of the plates openings (3).

The closed V-shaped edges (12) are intended to connect the sheets which form a salient angle (between each other).

The open V-shaped edges (13) are intended to connect the sheets forming a reentrant angle (between each other).

Before folding, the creases will be marked by grooving the cardboard sheets at a distance of 40 mm from the edges.

During the manufacturing process, molded gas-tight parts (33), (34) and (35) are stuck to each corner of the cardboard sheets on the raised edges. This is to ensure the corners' gas-tightness.

Parts (33) are intended for closed V-shaped edges.

Parts (34) are intended for opened V-shaped edges.

Parts (35) are intended for right-angled edges.

The right-angled edges (14) of the cardboard sheets are tightened on the gas-tight bay-frames by clamping plates (not shown) screwed onto the bay-frames.

An elastomeric gas-tight layer is placed between the border (14) and the bay-frame.

The closed V-shaped (12) and open V-shaped borders (13) of the cardboard sheets are gathered by pressing the Ω-shaped spring clamps (23). An elastomeric gas-tight layer will be placed between the pairs of curbs (12) or (13), in order to gas-tight the assembly of cardboard sheets.

The length of these Ω spring clamps is substantially equal to the length of each side of the cardboard sheets and to the lengths of the sides of the plates.

Tripod staples (24) pinch the three edges together in the corners of the sub-volumes or the volume.

Thus the entire superstructure and the underside of the building are wrapped in a gas-tight skin. Therefore, the interiors of the sub-volumes (2), and thus of the dwelling rooms, are cladded by a gas-tight skin.

The closed and gas-tight volume, wrapped by the gas-tight skin, is subjected to a high vacuum, less than 1 hPa. Full gas evacuation will be made in the long run in order to eliminate the gas molecules enclosed in the closed cells of the porous or hollow granules.

That is why the internal volume of the shell and the inner load-bearing walls and floors, is permanently connected to a vacuum pump (10). The latter is equipped with a detection and alarm system to prevent any excessive operation of this pump, a sign of accidental gas entry into the closed and gas-tight volume.

This control system will be connected to the global computer network (@) by wired or wireless network, for the tightness of the gas-tight volume to be monitored. A mechanical safety vacuum gauge will permanently indicate the vacuum level.

This permanent link to the global computer network is an alarm detecting any external attack, such as break-ins, against the shell.

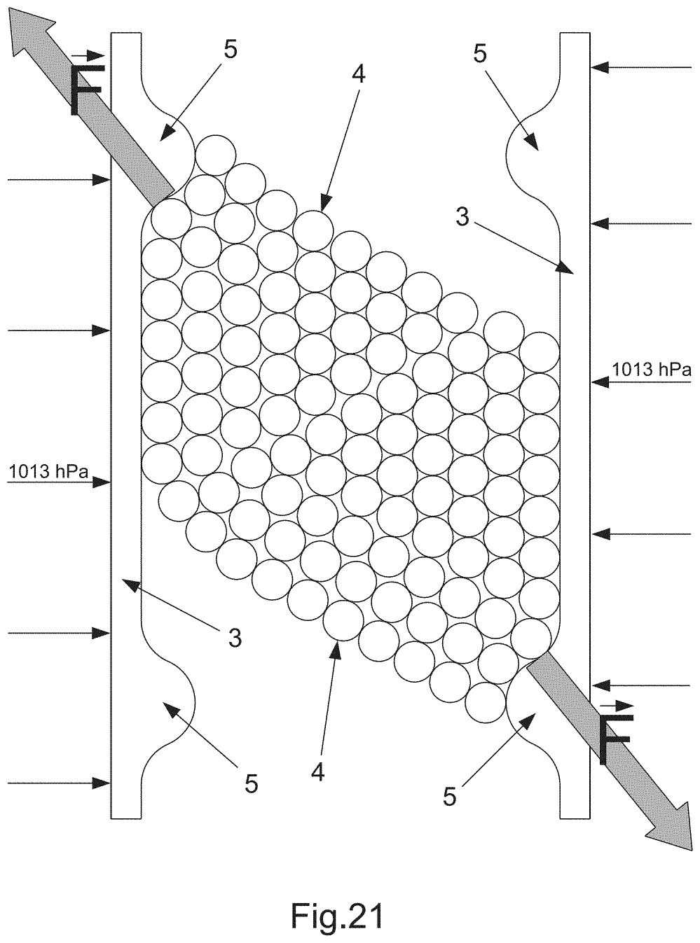

The gas-vacuum ensures the rigidity of the whole thanks to the so-called Magdeburg effect. The ribs (5) of the inner faces of the plates (3) are embedded in the granules (4) whose volume is rigidified by the pressure of the plates (see FIG. 21). The floors being stiffened, they are as quiet as a concrete floor.

The volume of gas-vacuum granules provides thermal and sound insulation and wind-bracing plates. The thermal conductivity of the shell varies from 0.006 to 0.004 watt/(meter ° K), depending on the granules type.

The optimum quality of the insulation will be maintained throughout the building's lifespan thanks to the vacuum pump (10).

The bay-frames (9), which are mounted in the shell are immobilized thanks to the so-called Magdeburg effect and the pressure of the granules on their outer bearing faces are embedded in the shell.

A plurality of vacuum metallized polymeric films (40) (37) coated with ion polarization layers (38) is inserted between the plates (3) and the gas-tight skin (8); solid, gelled or liquid electrolytes (39) are interposed between the ion-polarized layers.

The set of thin sheets constitutes a gas-vacuum electrochemical accumulator or a supercapacitor with solid or gelled or liquid electrolytic separator films.

The positive ion layers are connected together and constitute the anode of the accumulator (41). The negative ion layers are connected together and constitute the cathode of the accumulator (42).

The outlets of the anode and the cathode of the gas-tight skin are made between the pairs of contiguous borders (12) or (13). The elastomeric layer between the two edges allows gas-tightness around the anode and the cathode.

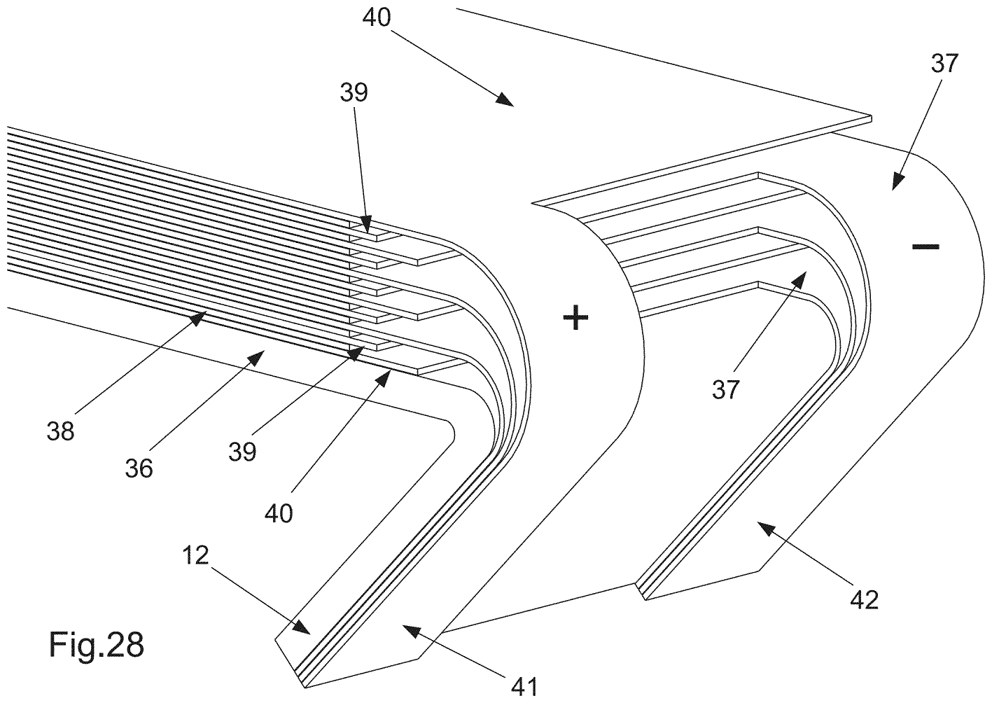

The elements within an accumulator are connected with each other in parallel (see FIG. 28). Each accumulator corresponds to a plate (3). The accumulators are connected with each other in series and deliver a voltage of 24 volts. The connection model is that of the batteries.

The polarity of the supercapacitors is determined by the polarity of the charge delivered by the photovoltaic panels (47), it is therefore determined by the way they are connected to one another.

The safety extra low-voltage electrical current is taken directly from behind the lining partitions to supply electrical outlets and devices which are protected from short circuits.

The plurality of ion polarization layers provides a barrier to any external electromagnetic field. The superstructure is thus electro-magneto-insulating.

The superstructure is placed on a bed of sand (28) which absorbs all the movements or tremors coming from the ground. The height of the sand depends on the seismic hazard, from 0.5 m to 2 m in height. This sand bed extends over a 20%-larger area than the support surface of the superstructure. It is particularly advantageous to use types of sand which are unsuitable for concrete manufacturing, such as desert sand. Because the grains of desert sand are rounded, they are even more suitable for the absorption of the soil's movements or tremors.

The self-standing superstructure, which is not fixed to the ground, is therefore anti-seismic.

Specially manufactured bolt/self-tapping screws (25) with a gas-tight cup (26) are provided for the fixation to the shorter side of certain wooden skeletons (46) on the cardboard sheets, as well as certain fixed domestic equipment, such as mechanical ventilation with heat energy recovery. The tightness of the cardboard sheets, which are drilled to ensure the passage of the screws, is provided by an elastomer O-ring (27), embedded in the groove of the cup (26) and compressed to the cardboard sheet by tightening the screw (25). The gas-tight cup and the self-tapping bolt/screw are forged and machined into a single part to ensure their tightness.

The bolt/self-tapping screws (25) are always screwed to locations indicated by printed marks on the cardboard sheets. On the back of these marks, the accumulators have a 30 mm diameter hole. These marks are facing the ribs (5) and (6) to have a maximum screw length.

In order to limit the quantity of granules, sub-volumes (11) which are not gas-tight are placed within the granules when the shell is too thick.

The rigid plates (3) are extruded, or laminated or molded in a laminated material or not, of plant origin. The ribs (5) are integrated in the plates manufacturing. The vaulted ribs (6) which are perpendicular to the ribs (5) are made of glulam or metal.

The spacers (7) consist of wires or cables of high-density polyethylene, or of nylon or steel.

The gantry-rafters (29) allow the installation of any cladding, wooden plates, roof battens or photovoltaic panels. They will preferably be placed on the shell without any fastening. The rafters (29) are connected to their top by connecting plates.

The skeletons (46) allow the installation of gypsum boards (45), OSB plates, and any lining plates. The space between the lining partitions and the cardboard sheets allows the passage of water circuits, ventilation as well as intranet and internet networks.

Inside the sub-volumes and behind the lining plates, thermal accumulators in the form of raw clay volumes (44) are placed on the base-floor.

All thermal storage materials can be used within the sub-volumes (2). All materials reflecting the sunrays can be used outside the volume (1).

A tar canvas will be placed under the superstructure before it is laid.

In floodable areas, doors and French windows will be watertight and will open outwards, pipe inlets will also be watertight. A backflow preventer will be fixed to the outlet of each sewage disposal. Waterproofness will be ensured up to the level of the highest flood ever observed. In the event of flooding, only the exterior cladding will be flooded.

The building is thus water-insulating.

General remarks regarding the superstructure's assembly:

The entire superstructure, including the interior fittings, will be prefabricated and pre-assembled in a workshop, only a screw fastening assembly will be used at the building's elevation site. The granules will be blown from a tanker truck.

The wall and cover elements (31) and (32) will be vibrated for the granules to occupy the entire interior volume and to be in contact with one another.

The panels (3) covering the upper sides of the shell are cut away from the top of the shell, a 0.60-meter wide cap (55) will be placed at the top of the shell after injection and vibration of the granules in the shell.

The conical bay-frames are embedded in the openings without any mechanical or chemical fixation, the pressure of the granules and the depression of the air immobilizing them.

The entire superstructure remains repairable, dismountable, modifiable and removable to another location.

A single gas suction port is required and sufficient for the entire superstructure.

The vacuum pump (10) is advantageously placed inside the superstructure.

### Considerations

For a 250-sqm dwelling including a 50-sqm veranda, the surface of the supercapacitors or electrochemical accumulators may be 2000 sqm if the external surfaces are used, including the underside of the base of the building. Multiplied by 10 pairs of ionic layers, this can represent 20000 sqm of electrostatic or electrochemical accumulation. The output direct current is 24 volts, with very low safety voltage.

It is simple to place a 220-volt AC micro inverter/transformer at the end of the power outlet if necessary. It should be noted that the 24-volt DC/220-volt AC inverters/transformers, currently fixed to photovoltaic panels' outlets, have a limited lifespan and consume a fraction of the electricity delivered by these panels. Their removal is a progress.

The granules, manufactured with red mud extracted from bauxite, contain traces of uranium 238 and thorium 232. Their radioactivity will be absorbed by the 24 ionic metal layers of the accumulators and will not be dispersed in the atmosphere, for it will be vacuum.

### Exemplary Embodiment

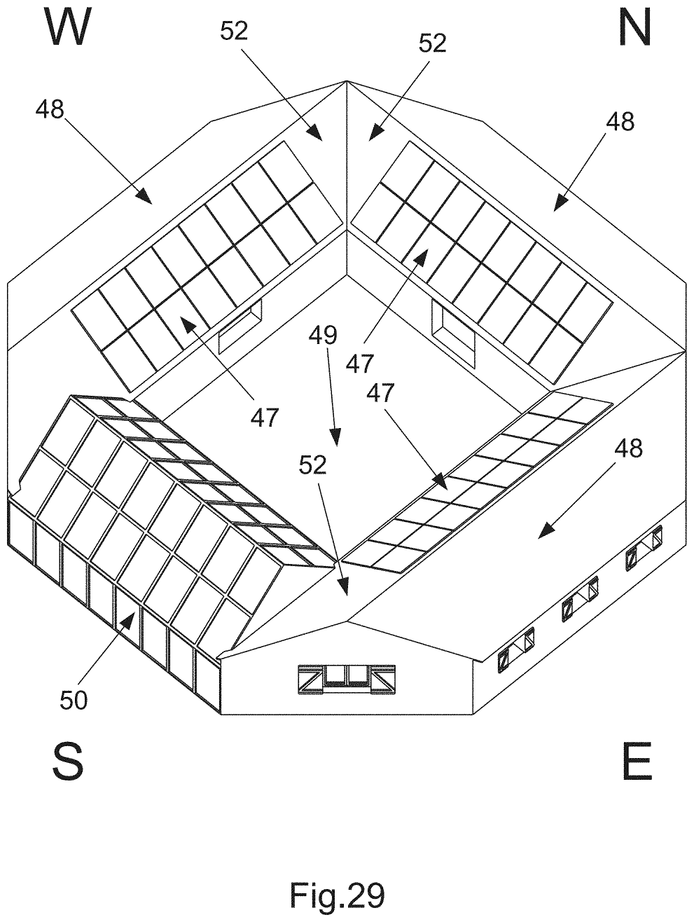

An exemplary embodiment is proposed in the form of a single-story dwelling (FIG. 29), this dwelling includes an interior garden (49) whose ground area has a minimum value of 25% of the total supporting surface of the building on the ground.

As the insulation is practically absolute, it is not necessary to build a dwelling with a floor, this type of construction being mainly intended for the recovery of the heat source emitted by the lower story.

Solar energy capture requires a maximum sun exposure area. This surface is limited with a multi-story building.

The proposed dwelling model has a large roof surface (48) and (52) on which photovoltaic panels and/or solar panels can be installed.

This dwelling model with central opening and hidden interior slanting roofs (52) makes it possible to make the photovoltaic panels/solar panels (47) invisible to an observer standing outside the building and at ground-level (not in a high place).

The implantation of the superstructure without foundation makes it possible to integrate the vegetation within the dwelling, the root system of one or several trees (51) planted in this garden being able to develop without barrier.

An excavation (54) of the garden surface (49) is dug and filled with topsoil prior to the implantation of the building.

Air enriched in oxygen thanks to leafy plantations planted in the indoor garden (49) is captured, filtered and injected into the dwelling by mechanical ventilation (53).

In the northern hemisphere, the south-facing frontage consists of a veranda (50), a source of solar energy thanks to solar radiation which heats the air circulating inside the veranda. This hot air is injected into the dwelling by mechanical ventilation (53).

In the southern hemisphere, the veranda will be north-facing.

Future advances in solar cell efficiency will allow photovoltaic panels to be placed inside the veranda (50), allowing trees planted in the garden to grow upward without running the risk of hiding the panels (47) from solar radiation.

The house is semi-mobile, it can be moved after being disassembled and reassembled. Once the building is dismantled, the land is once again free of any construction.

### DETAILED DESCRIPTION OF FIGURES

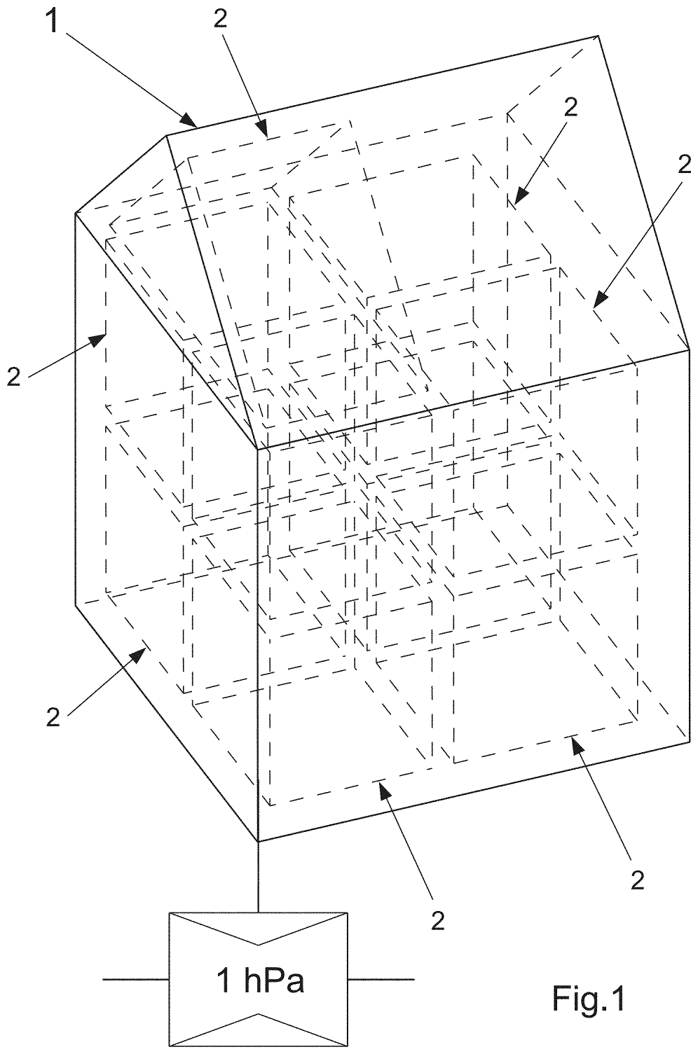

FIG. 1: Representation of the overall volume (1) encompassing sub-volumes (2), the assembly is vacuum by the vacuum pump (10). This figure schematically illustrates claim 1.

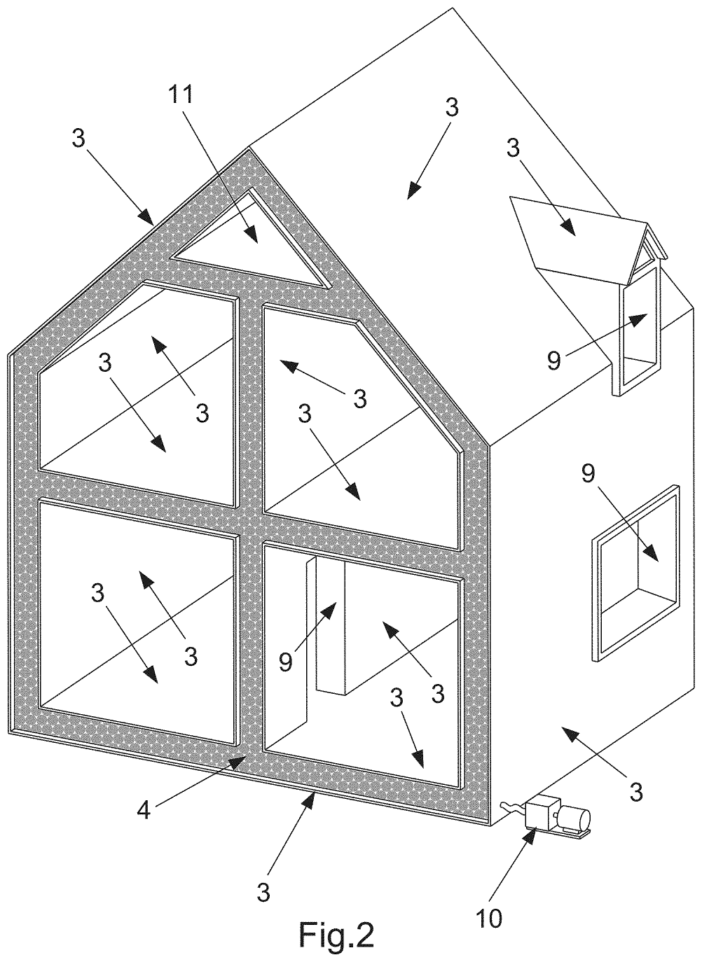

FIG. 2: View of a building, whose gable wall is open, showing the plates (3), the granules (4) as well as the vacuum pump (10).

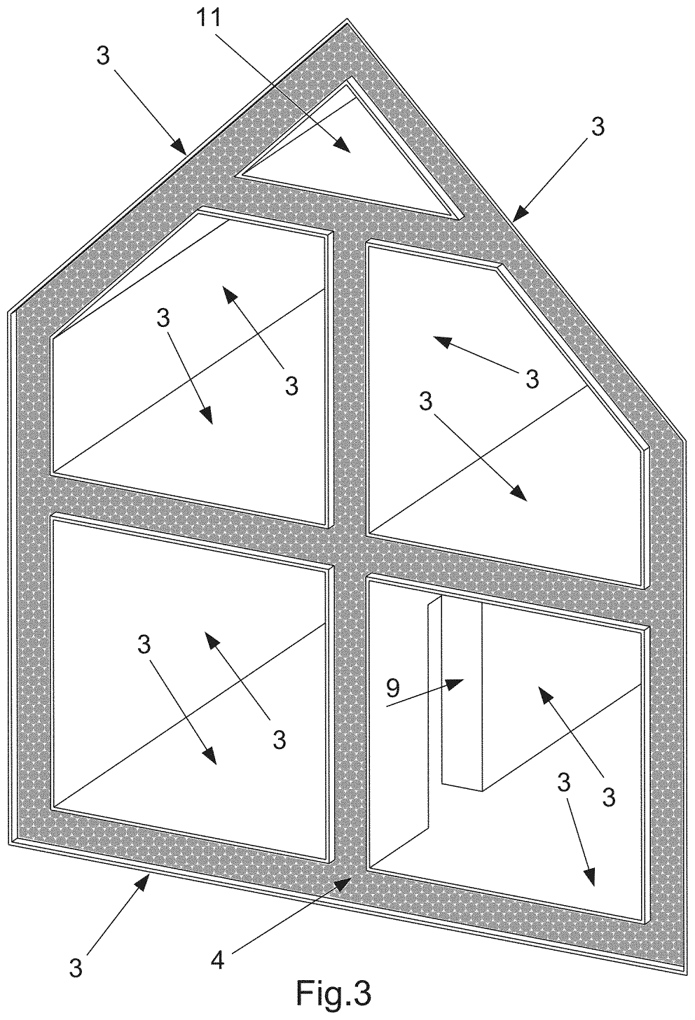

FIG. 3: Zoom +1.5 on the open gable wall of FIG. 2.

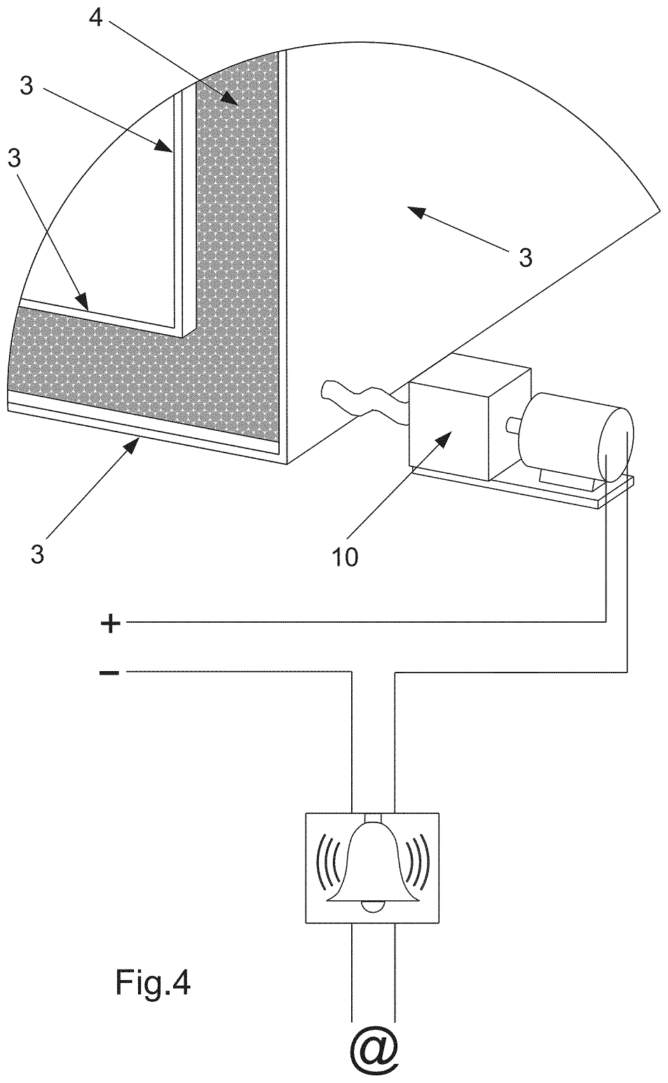

FIG. 4: Detail of FIG. 2, schematic diagram of the vacuum pump powered by a direct current circuit+/−, an alarm signals any excessive operation of the pump, the control circuit is connected to the global computer network (@).

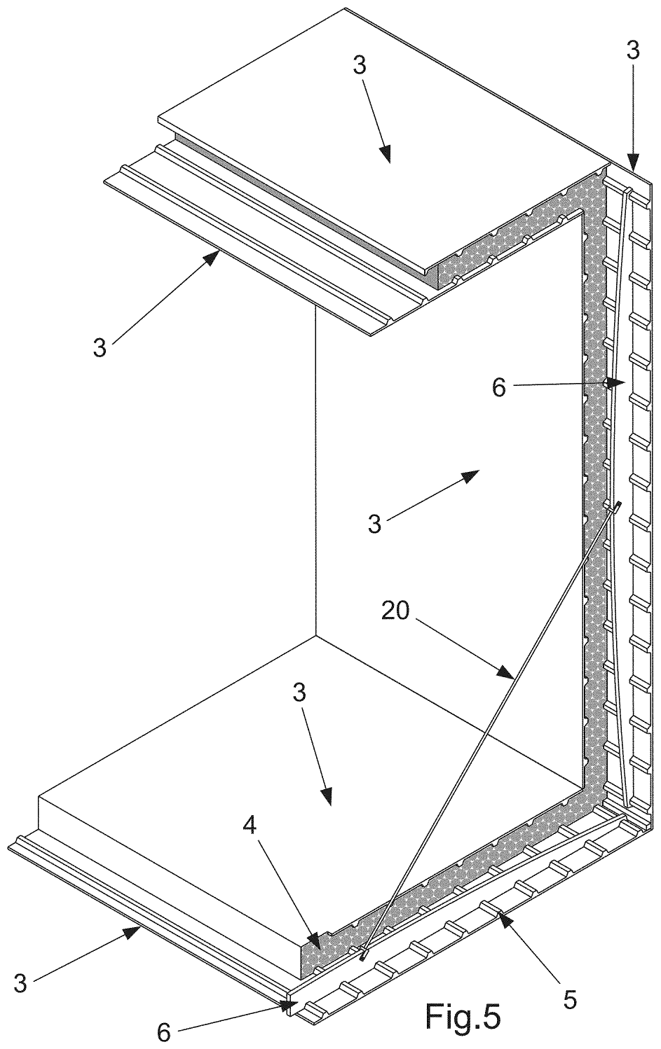

FIG. 5: Partial view of two floors and a wall, the base and a wall are braced by the tie rod (20) fixed to the vaulted ribs (6).

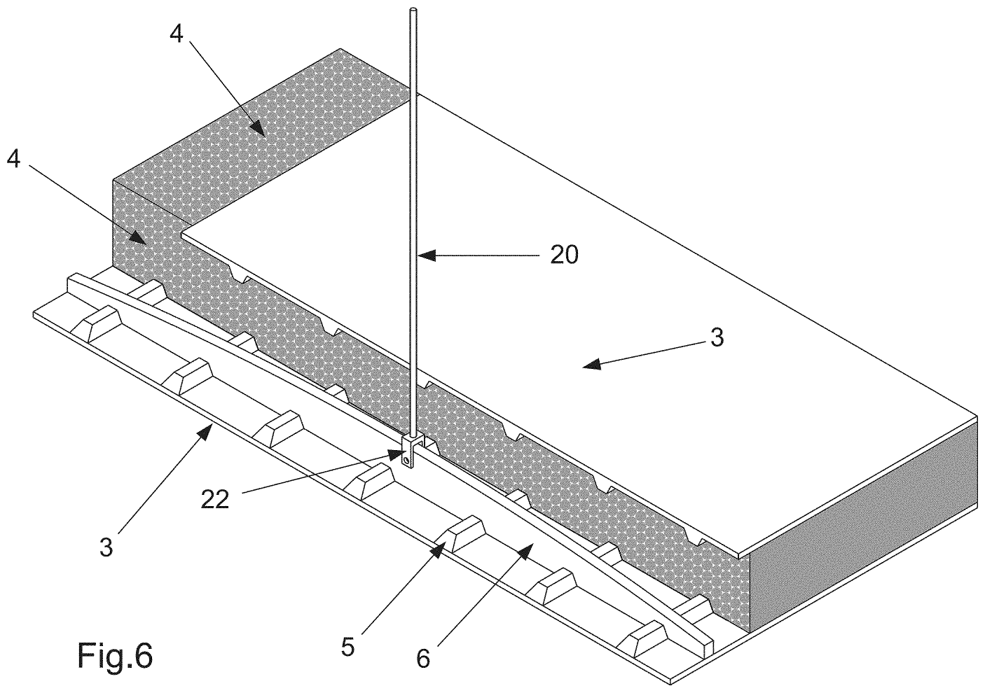

FIG. 6: Detailed partial sectional view off any part of the shell showing the constituent elements of the shell: ribbed plates (3), granules (4), tie rod (20) and clevis (22).

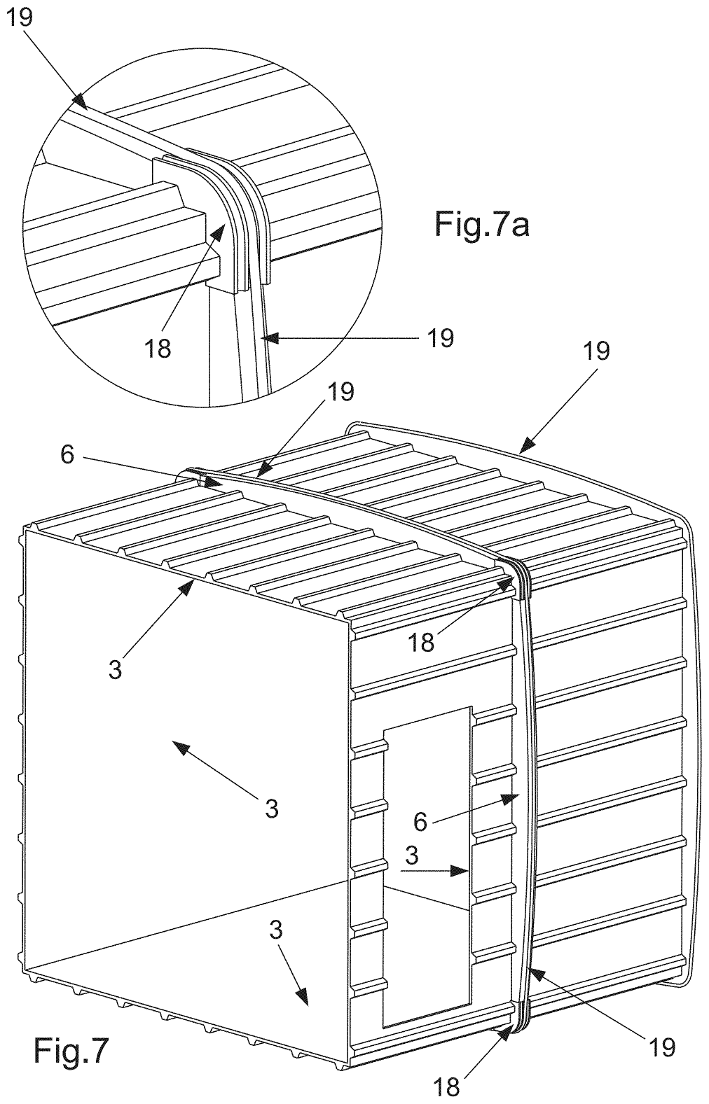

FIG. 7: Representation of the inner walls chained by an endless cable (19). A second cable (19) is pending. The connecting mounting corner brackets (18) hold the vaulted ribs (6) and are used as cable guides.

FIG. 7A: FIG. 7's zoom on a connecting mounting corner bracket (18).

FIG. 8: Pre-assembled wall element (31) consisting of plates (3) connected by spacers (7) and enabling a precise spacing between the plates. The spacers (7) consist of 0.5-to-2 mm diameter wires. Mounting corner brackets (15) and (16) make it possible to assemble different elements together. The lower mounting corner brackets (15) allow to fix the elements (31) to the base. The screws (17) fix the mounting corner brackets to the plates.

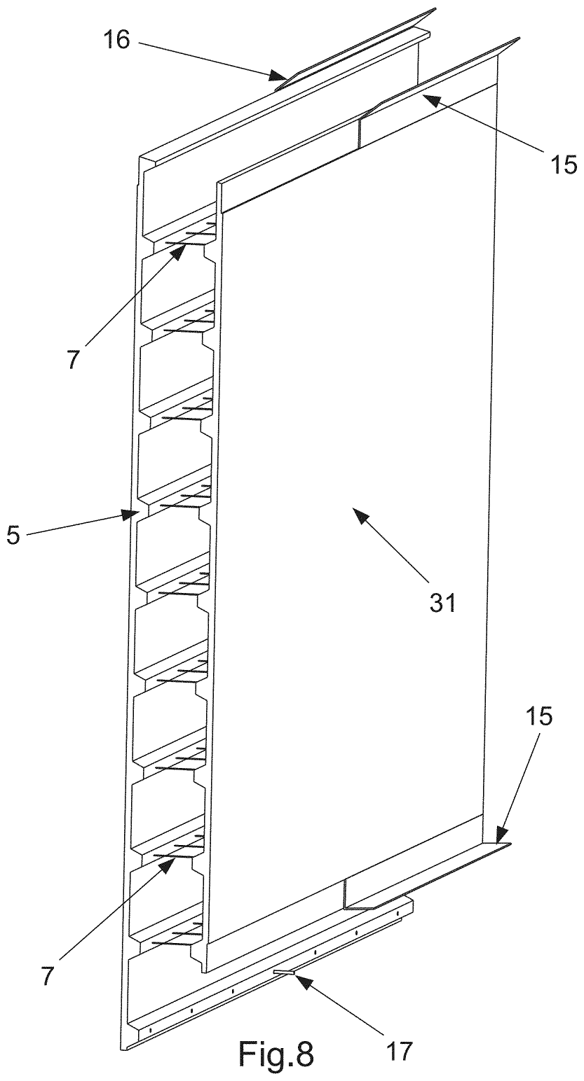

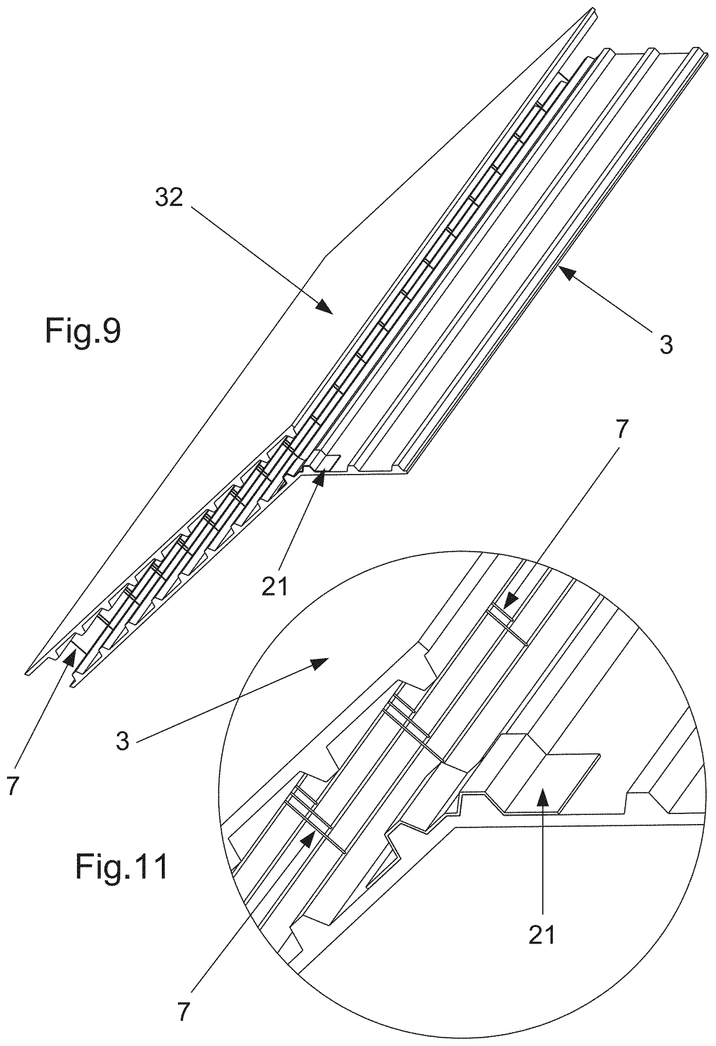

FIG. 9: Pre-assembled wall element (32) consisting of plates (3) connected by spacers (7) to enable a precise space between the plates. The spacers (7) consist of 0.5-to-2 mm diameter wires. The connecting plates (21) make it possible to assemble different elements together. The panels (3) are cut away from the top roof to make room for a (55) 0.60-meter wide cap.

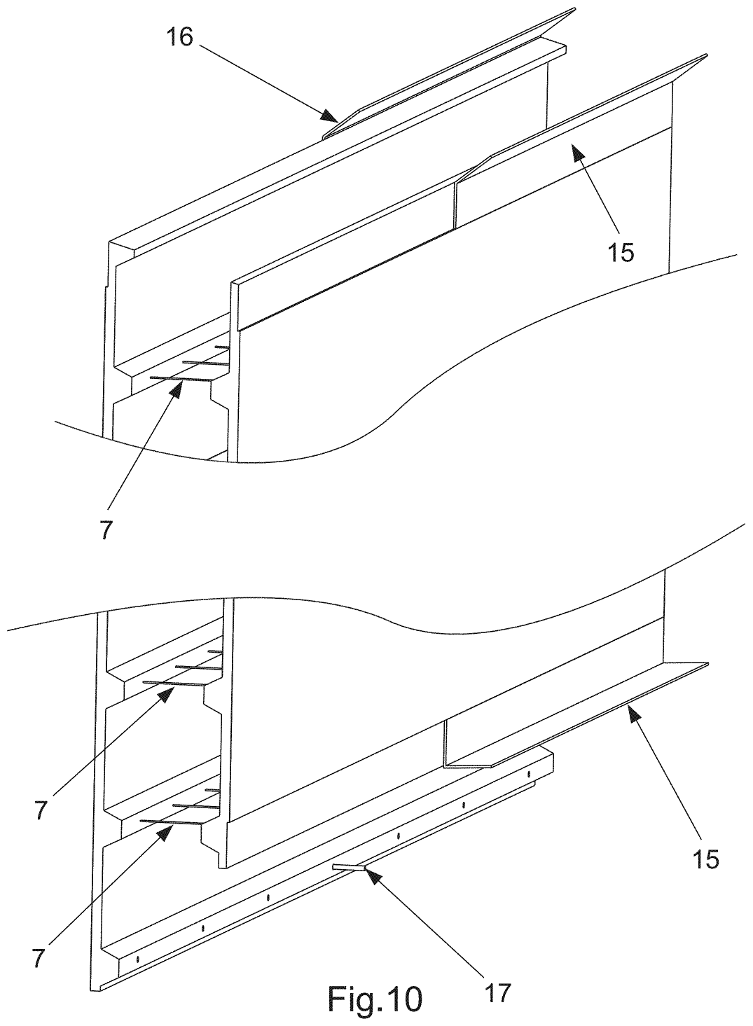

FIG. 10: Zoom on the mounting corner brackets (15) and (16).

FIG. 11: Zoom on a connecting plate (21).

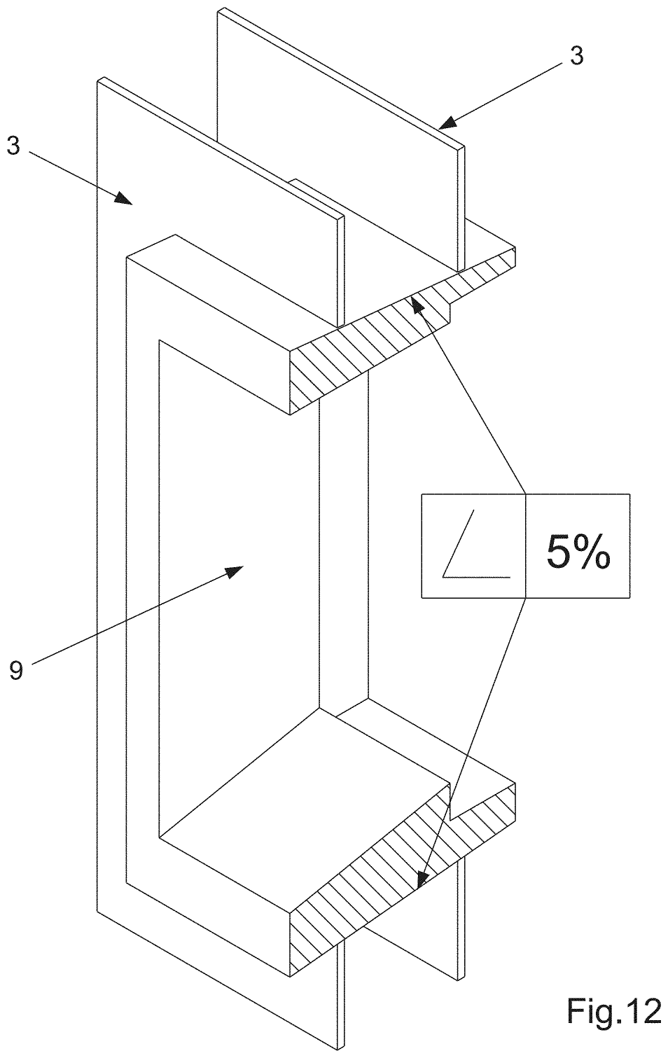

FIG. 12: View of a half bay-frame (9) whose four bearing faces have a 5% slope increasing towards the outside of the building.

FIG. 13: Schematic representation of a skin sheet (8) with closed V-shaped edges and corner seal (33). Four corner seals are stuck to the four corners of the sheet (8). Zoom on the seal (33).

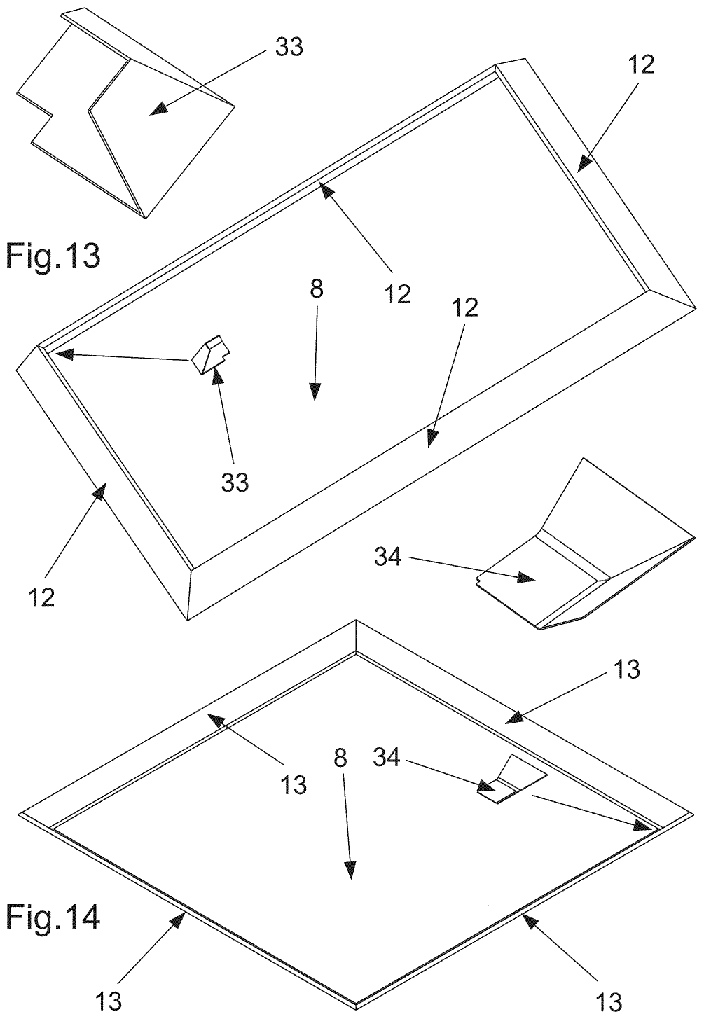

FIG. 14: Schematic representation of a skin sheet (8) with open V borders and gas-tight corner seal (34). Four gas-tight corner seals are stuck to the four corners of the sheet (8). Zoom on the corner seal (34).

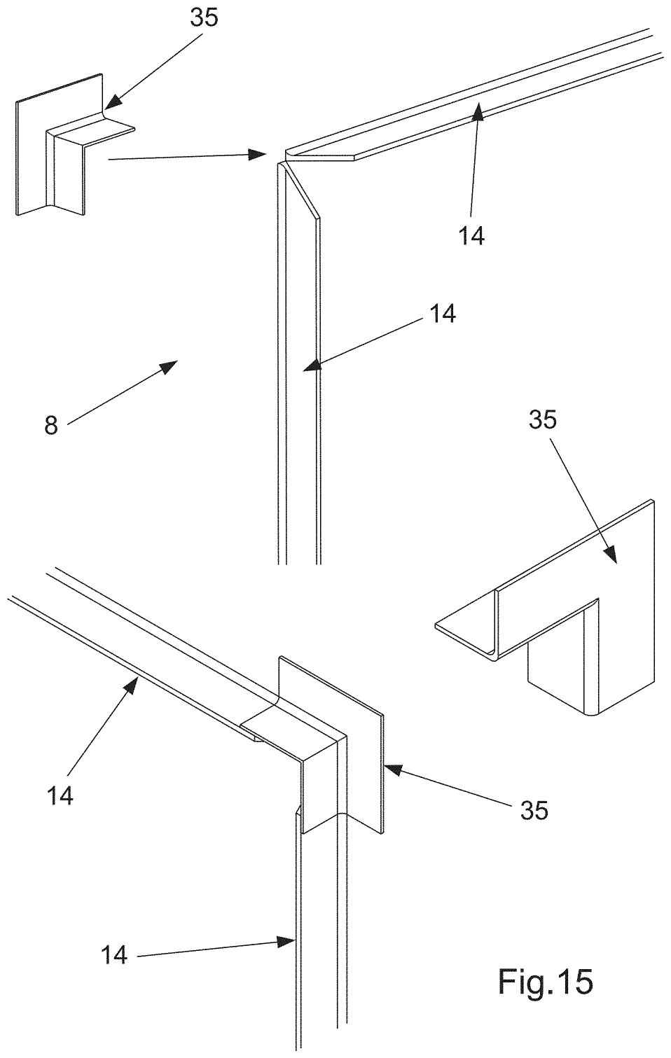

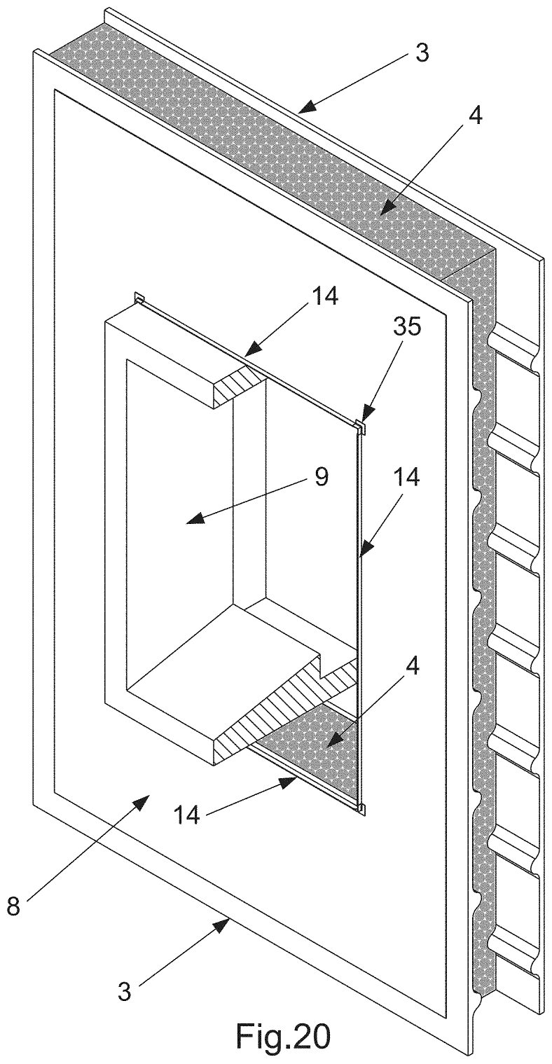

FIG. 15: Schematic representation of a skin sheet (8) with right-angled edges and a gas-tight corner seal (35). Four corner gas-tight seals are stuck to the four corners of a hole in the skin (8), see FIG. 20. Zoom on the gas-tight corner seal (35).

FIG. 16: Sectional view of two V-shaped edges pressed together (12) and Ω-shaped spring clamp (23).

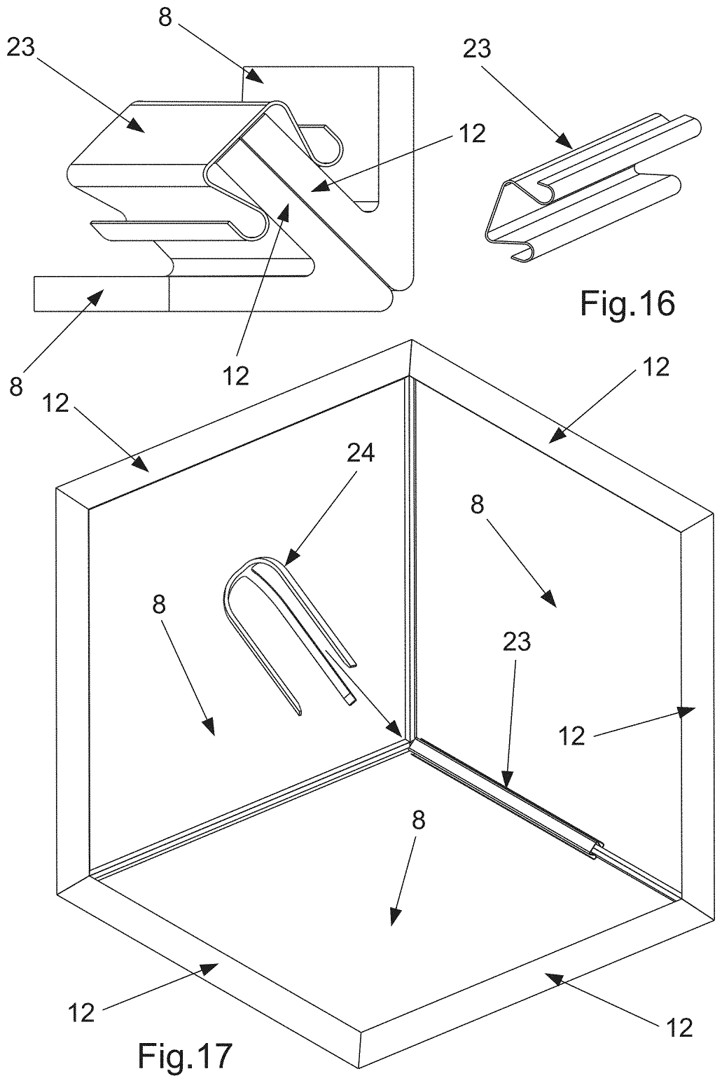

FIG. 17: Diagram of an inner angle of a sub-volume with two closed V-shaped edges (12) pinched by a Ω spring clamp (23) and magnified view of a ready-to-use tripod staple (24).

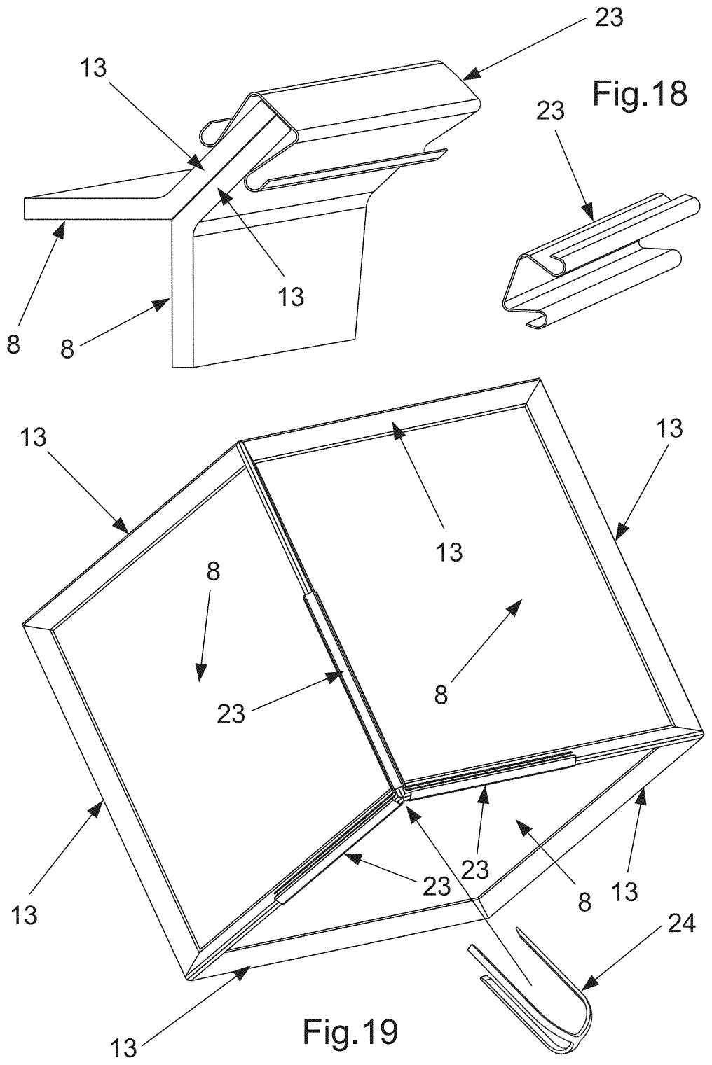

FIG. 18: Sectional view of two contiguous open V borders (12) and Ω spring clamp (23).

FIG. 19: Diagram of an outer corner of a volume with six open V contiguous edges (13) pinched by three Ω spring clamps (23) and magnified view of a tripod staple (24).

FIG. 20: View of a gas-tight bay and recessed half gas-tight bay-frame (9), the edges (14) are tightened on the gas-tight bay-frame by top-screwed clamping plates.

FIG. 21: Schematic diagram of the plates' (3) wind-bracing principle. The ribs (5) brace themselves in the granules (4) stiffened by the atmospheric pressure exerted on the outer face of each plate (3). Reaction forces: F

FIG. 22: Representation of a tie rod (20) embedded in the granules inside a floor.

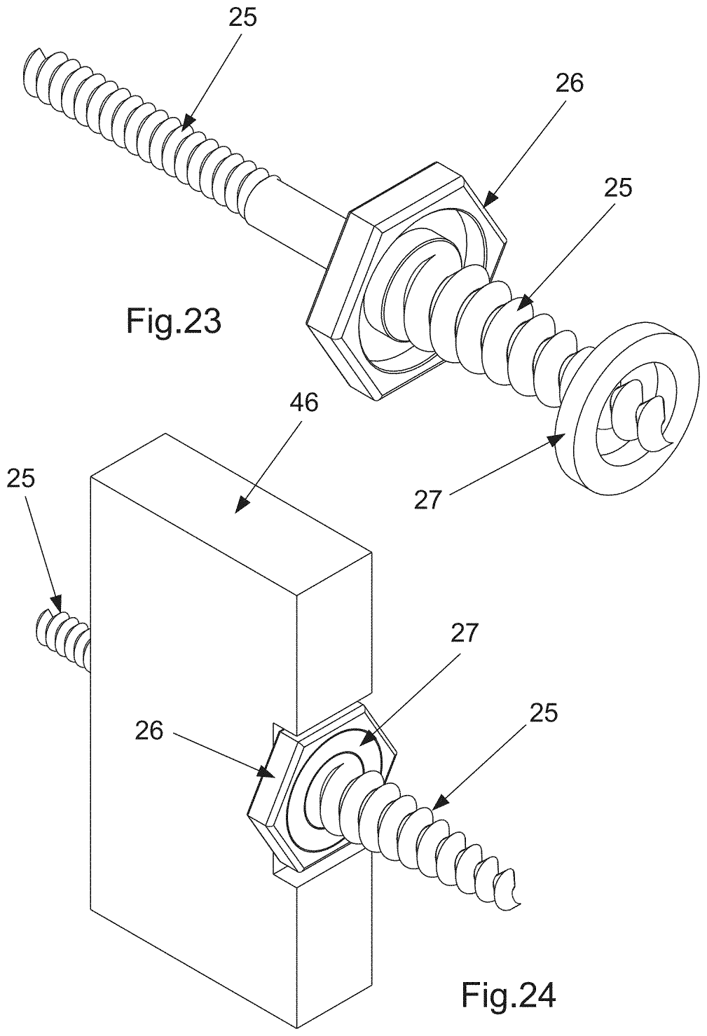

FIG. 23: Bolt/self-tapping screw (25) with gas-tight cup (26). A torus (27) of elastomer is embedded in the circular groove of the gas-tight cup.

FIG. 24: Mounting of a bolt (25) on a skeleton (46), the O-ring (27) is mounted in its cup (26). An unrepresented nut clamps the skeleton to a plate (3).

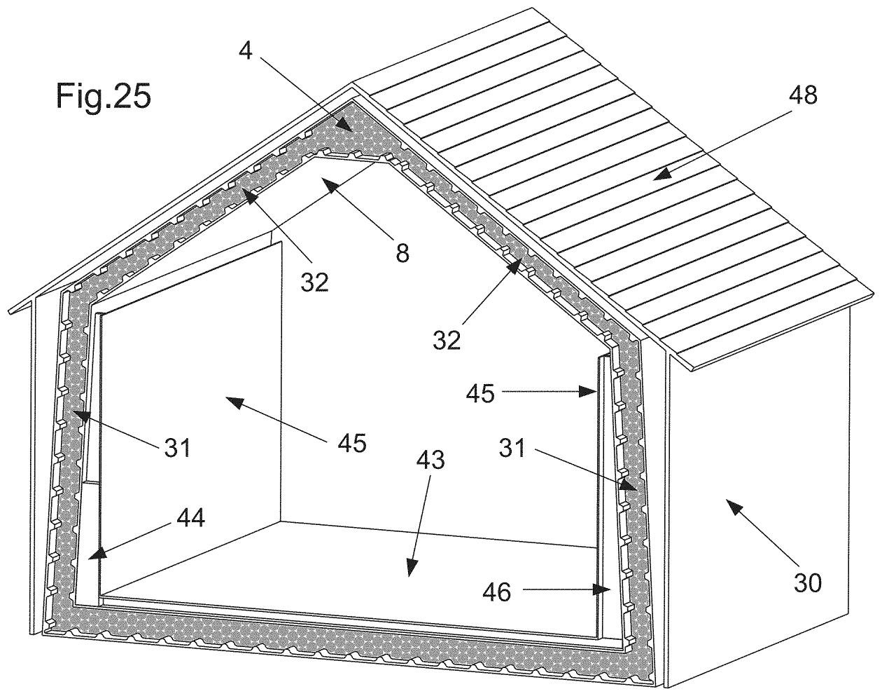

FIG. 25: Sectional view of an embodiment of a single-story house with a gantry shell (31) and (32). The cladding panels (30) and the roof (48) are fixed to the gantry-rafters (29). The lining partitions (45) are fixed to the skeletons (46). A heat accumulator (44) is shown.

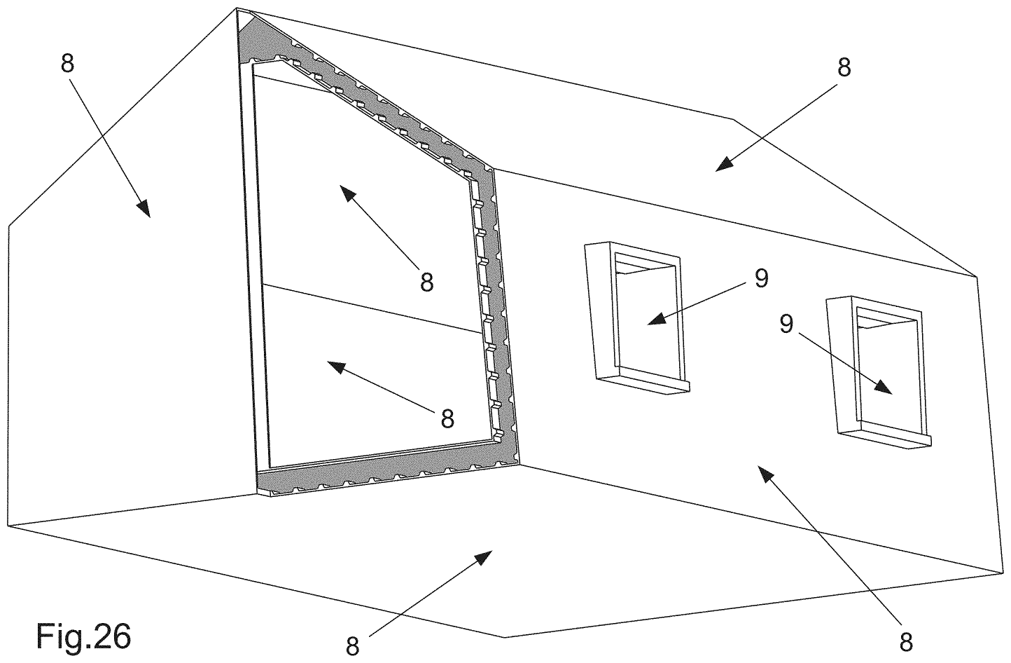

FIG. 26: View of the complete coating of a house with the skin (8).

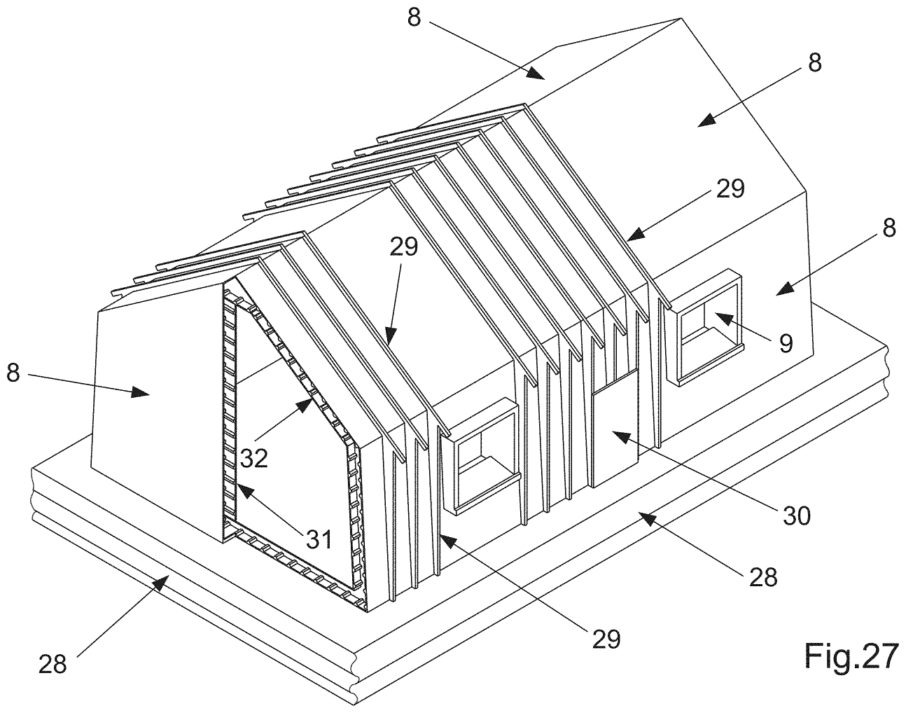

FIG. 27: View of a superstructure laid on a sand bed (28) with a plurality of gantry-rafters (29). An outer cladding board (30) is shown.

FIG. 28: Schematic diagram of an electricity accumulator. The accumulator's thickness is 2-3 millimeters for ten accumulator elements. The thickness of the anode and the cathode is 100 micrometers.

FIG. 29: Aerial view of a house with an indoor garden (49). The photovoltaic/solar panels (47) are fixed to the interior slanting roof (52) on the indoor garden side (49). In the northern hemisphere, the veranda (50) is south-facing.

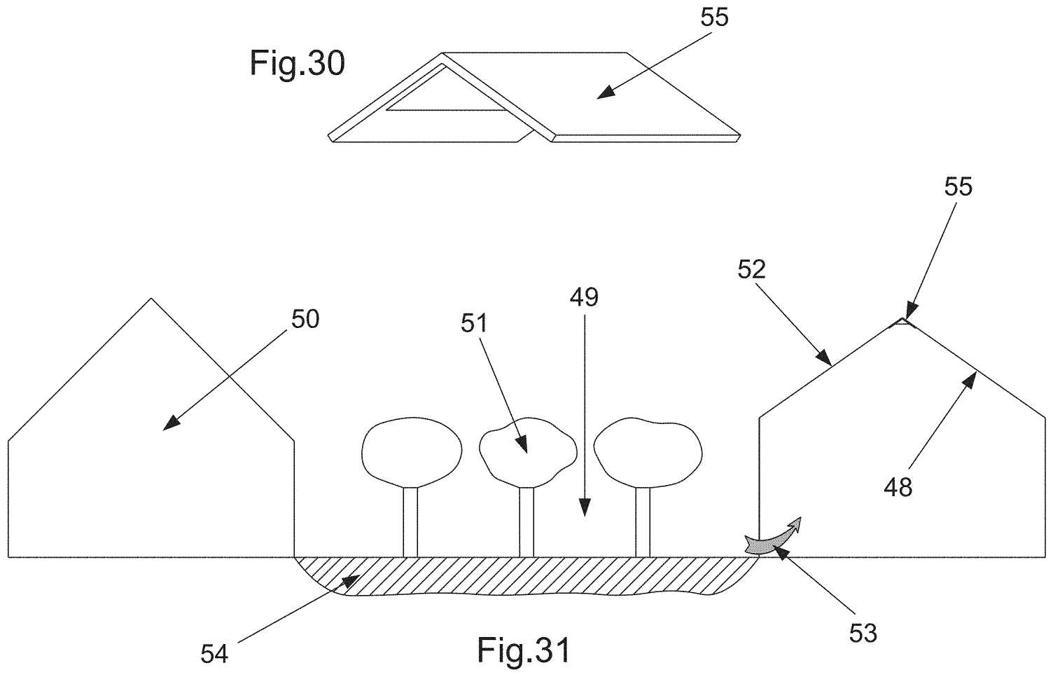

FIG. 30: Cap closing the top of the shell after complete injection of the granules (4). Gas-vacuum keep it in place.

FIG. 31: Section of a house with indoor garden, low ventilation entrance (53), preliminary excavation (54) of the indoor garden and topsoil filling, closure cap (55).

### BILL OF MATERIEL

1—Total volume 2—Sub-volume 3—Plate
4—Granules 5—Rib 6—Vaulted rib 7—Spacer
8—Skin/Skin-accumulator
9—Gas-tight bay-frame 10—Vacuum pump
11—Non gas-tight sub-volume
12—Closed V-shaped edge 13—Open V-shaped edge
14—Right angle edge
15—Inner mounting corner bracket
16—Outside mounting corner bracket
17—Mounting screw corner brackets
18—Mounting corner bracket/cable guide
19—Cable 20—Tie rod or shroud
21—Connecting plate 22—Clevis
23—Ω-shaped spring clamp
24—Tripod staple
25—Bolt/self-tapping screw
26—Cup 27—O-ring 28—Sand
29—Gantry-rafters 30—Cladding panel
31—Wall element 32—Cover element
33—Gas-tight V closed 34—Gas-tight V, open
35—Right angle gas-tight 36—Cardboard sheet
37—Metal film
38—Ion polarization layer
39—Sheet, solid/gelled/liquid electrolytic layer
40—Vacuum metallized polyester film
41—Anode 42—Cathode 43—Floor
44—Thermal accumulator 45—Lining partition
46—Skeleton for lining partition
47—Photovoltaic panels/solar panels
48—Roof 49—Indoor garden 50—Veranda
51—Leafy tree 52—Interior slanting roof
53—Mechanized ventilation capturing new air
54—Excavation/topsoil
55—Upper shell closing cap
@—Internet link computer
+ And −: Positive and negative power supply terminal
Bell symbol (FIG. 4): Air input alarm

What is claimed is:

1. A self-standing building superstructure with self-insulating electricity-accumulating evacuated volume, the self-standing building superstructure consisting of an overall volume formed by a plurality of contiguous rigid plates forming an outer envelope which encompasses the entire building and of living or reception rooms, also constituted by a plurality of contiguous rigid plates forming one or more sub-volumes, wherein
the overall internal volume of the superstructure is filled with substantially spherical, rigid lightweight granules scattered without any binder, in which at least one of the said sub-volume or dwelling rooms is immersed, in which the overall internal volume of granules is under a gas-vacuum, the gas-vacuum enabling the superstructure to stiffen and to become insulating;
the each sub-volume is physically, phonetically and thermally isolated, independently of the other sub-volumes within the overall volume.

2. The self-standing building structure according to claim 1, wherein an outer casing of the superstructure and a plurality of walls of the living rooms are composed of rigid plates extruded or laminated or molded in a laminated or non-laminated material, of mineral and/or vegetable and/or petrochemical origin and the granules pressed by the outer casing and the plates facing said casing form a cocoon continuous shell.

3. The self-standing building superstructure according to claim 1, wherein the light weight granules are scattered, and fill the internal volume of the shell, the walls and the floors, without any binder to agglomerate them; and
are either an expanded geopolymer, or expanded clay or foam glass, or hard, stiff fruit cores.

4. The self-standing building superstructure according to claim 2, wherein the rigid plates have their face internal to the shell, the load-bearing walls and the floors, lined with a plurality of ribs parallel to each other, in the form of corrugations or gear rack teeth, the direction of these ribs is orthogonal to the shear stresses exerted on the shell, the inner load-bearing walls and the floors and these ribs, embedded in the granules and whose volume is stiffened by the gas vacuum, allow wind-braced walls.

5. The self-standing building superstructure according to claim 4, wherein the outer casing of the shell is guyed from the inside by tie rods embedded in the granules and the walls of the dwelling rooms are chained from the inside of the shell, the inner load-bearing walls and the floors, by cables embedded in the granules.

6. The self-standing building superstructure according to claim 4, wherein in each opening made in the shell the inner load-bearing walls and the floors is embedded a gas-tight bay-frame or opening-frame whose external installation's housing shape is conical and the bay-frame is held in place by the gas-vacuum only, which is exerted on its embedded outer faces, without mechanical or chemical fixation.

7. The self-standing building superstructure according to claim 1, wherein a gas-tight skin clads all the external surfaces of the superstructure's outer casing and the walls of the dwelling or public rooms.

8. The self-standing building superstructure according to claim 1, wherein the volume of the shell, the inner load-bearing walls and the floors is subjected to a gas-vacuum of less than 1 hPa and this vacuum is controlled by a vacuum pump which is installed in situ permanently, a single gas suction port is necessary and sufficient for the entire superstructure and the gas-vacuum volume of the shell, the walls and the floors is delimited by the gas-tight skin and the embedded outer faces of the bay-frame or opening-frame.

9. The self-standing building superstructure according to the claim 8, wherein the vacuum pump is advantageously placed inside the superstructure and the superstructure is equipped with a detection and alarm system connected to the global computer network in order to prevent any excessive operation of said pump.

10. The self-standing building superstructure according to claim 7, wherein the gas-tight skin consists of paper sheets of grammage 250 to 600 gr/m² sealed on their side plate side by a layer of Ethylene Copolymer/Vinyl Alcohol [EVOH] and hot absorption of the outer side with a medium or long chained chloroalkane, makes the paper both incombustible and non-degradable.

11. The self-standing building superstructure according to claim 1, wherein the gas-tight skin is removable and for this, each plate corresponds to an insulated sheet of shape and dimensions identical to the plate;
these sheets are interconnected by their folded edges and raised at a V-shaped angle the openings in said sheets are connected to gas-tight bay-frames by their folded edges and raised at right angles;
the closed V-angle curbs are intended for the salient angles formed between two sheets, the open V-shaped curbs are intended for the reentrant angles formed between two sheets;
a thin elastomeric gas-tight layer is inserted between these adjacent edges;
the perimeter of the borders and corresponds to the perimeter of the plates, the perimeter of the borders corresponds to the perimeter of the openings made in the sheets and to the perimeter of the opening made in the plates;
the contiguous edges of the sheets which are edge-to-edge are pressed together by Ω-shaped profile spring clamps, the length of each spring clamp being substantially equal to the length on each side of the sheets and plates;
the right-angled edges are contiguous with the outer faces of the bay-frame, they are pressed on the bay-frames' faces by clamping plates screwed at the top;
a tripod staple clamps the three contiguous edges into the corners of the sub-volumes and the overall volume;
the corners of the raised edges are gas-tight by molded parts glued, in each inner corner, to the borders and in each outer corner to the edges;
the superstructure is anti-seismic and waterproof if it is placed on a bed of sand which absorbs all movements or shaking of the ground, its thickness is a function of the seismic hazard and its surface is 20°/o greater than the bearing surface of the superstructure on the ground.
any accessory is attached to the gas-tight skin by single part forged bolt/self-tapping screws, a cup presses an O-ring on the skin between the bolt and the screw parts and the holes pierced in the skin are sealed due to the O-rings.

12. (canceled)

13. (canceled)

14. (canceled)

15. The self-standing building superstructure according to claim 7,
wherein insertion between the gas-tight skin and the plates, of a superposition of metallized polymeric thin films, cladded with ion-polarized layers and layers or electrolytic separator sheets are interposed between the ion-polarized layers;
the electrolytic separating and ion-polarization superposed layers constitute electro-chemical vacuum accumulator cells of gas storing an electrochemical charge and
the electricity, when it is in very low DC safety voltage, is taken directly from the skin-accumulator behind the doubling partitions, without distribution by a distribution board or an electrical circuit; each connection is protected against overvoltages or short circuits;
the plurality of metallized polymeric thin films enveloping the building, provides a barrier to external electromagnetic pollution and is advantageously used as a receiver antenna for these electromagnetic waves that will be concentrated in a shielded cable.

16. (canceled)

17. (canceled)

18. (canceled)

19. The self-standing building superstructure according to claim 15, wherein the superposition of thin metallized polymeric films with ionic layers and charged with electricity provides a radiation barrier comprising ionizing alpha and beta β isotopes 235 and 238 of uranium, isotopes 232 of thorium and isotopes 40 of potassium and the mineral granules contain particles of uranium, thorium and potassium.

20. The self-standing building superstructure according to claim 1, wherein the self-standing building structure comprises an open-air interior garden in the center and the roof is in its center just like floor base, which is also open to match the opening of the roof, both openings are of substantially equal shape and size and the superstructure is covered by cladding panels, photovoltaic panels and/or solar panels, roof and an interior slanting roof.

21. (canceled)

22. (canceled)

23. (canceled)

24. The self-standing building superstructure according to claim 20, wherein the three interior slanting roof sections of the building situated on the west side, north, east in the northern hemisphere, eastern sides, south, west in the southern hemisphere, sloping down to slope down to the said central opening, completely or partially composed of photovoltaic panels and/or solar panels.

25. The self-standing building superstructure according to claim 20, wherein the cover and the facade, almost vertical on the side of the central opening have been replaced by a roof, an interior slanting roof and cladding panels consisting of transparent glass panels that allow solar radiations to penetrate through the central opening or indoor garden and the said roof, cladding panels and slanting roofs are located on the south side in the Northern hemisphere and on the north side in the Southern hemisphere.

26. (canceled)
